(19) United States
(12) Patent Application Publication
(10) Pub. No.: US 2002/0091817 A1
(43) Pub. Date: Jul. 11, 2002

(54) Performance measurement system and method

(75) Inventors: Thomas L. Hill, Dallas, TX (US); Preston L. Bice, McKinney, TX (US); Mike W. Stuart, The Colony, TX (US)

Correspondence Address: Baker Botts L.L.P., 2001 Ross Avenue, Dallas, TX, 75201-2980, US

(73) Assignee: Electronic Data Systems Corporation

(21) Appl. No.: 09/746,594

(22) Filed: Dec. 21, 2000

(51) Int. Cl. G06F 15/173

(52) U.S. Cl. 709/224; 709/219

(57) ABSTRACT

An Internet based performance measurement system includes a server operable to receive performance perception data from a client corresponding to a performance query. The system also includes a database comprising a metric corresponding to the performance query. The metric comprises actual performance data corresponding to the performance query. The system also includes a performance engine operable to access the performance perception data and the metric. The performance engine is operable to compare the performance perception data to the metric to determine variations between a client perception of performance and actual performance.

### BACKGROUND OF THE INVENTION

Many businesses, associations and other groups or organizations often desire feedback from customers or other interactive relationships to determine effectiveness, improvement suggestions, satisfaction, likes, dislikes, and other relationship-based information. Surveys are one method of obtaining the desired information. For example, after completing a transaction, a customer may be provided with a survey containing a variety of different questions corresponding to the completed transaction. The survey may be presented to the customer in written form, orally, or may be provided using other suitable presentation methods.

Conventional survey techniques for obtaining information, however, suffer several disadvantages. For example, in the case of a written survey form, many of the survey forms are not returned to a survey source. Additionally, if a generally large quantity of queries are contained in the survey, the person completing the survey may become distracted or disinterested in completing the survey. As a result, the survey results generally provide incomplete and possibly inaccurate conclusions. Additionally, receiving information via oral or telephone surveys is generally difficult to obtain, costly, and oftentimes met with disapproval from the surveyee due to inconvenience or time limitations.

### SUMMARY OF THE INVENTION

Accordingly, a need has arisen for an improved system and method for obtaining performance information that provides greater control and accuracy of the information. According to the present invention, the problems and disadvantages associated with previous survey and performance evaluation techniques has been substantially reduced or eliminated.

According to one embodiment of the present invention, an Internet based performance measurement system includes a server operable to receive performance perception data from a client corresponding to a performance query and a database comprising a metric corresponding to the performance query. The metric includes actual performance data corresponding to the performance query. The system also includes a performance engine operable to access the performance perception data and the metric. The performance engine is operable to compare the performance perception data to the metric to determine variations between a client perception of performance and actual performance.

According to another embodiment of the present invention, a method for Internet based performance measurement includes generating a performance query web page having a performance query and receiving performance perception data from a client corresponding to the performance query. The method also includes retrieving a metric corresponding to the performance query. The metric includes actual performance data corresponding to the performance query. The method further includes comparing the performance perception data to the metric to determine variations between a client perception of performance and actual performance.

The present invention provides a number of important technical advantages over prior systems and methods. For example, according to one embodiment of the present invention, a client's perception of performance is compared to actual performance data to determine discrepancies or variations between actual and perceived provider performance. Thus, the variations between actual and perceived performance between a service provider and a client may be evaluated and corrective measures instituted at the client or service provider level.

Additionally, the present invention provides greater survey feedback control than conventional survey systems and techniques by monitoring survey feedback or perception data received from the client. For example, according to one embodiment of the present invention, a communication is transmitted to the client indicating an Internet or web site for providing performance perception data corresponding to one or more performance queries. The communication identifies one or more client personnel to provide the performance perception data. The system records and updates the comparison between the performance perception data and actual performance data for each of the identified client personnel on a substantially real-time basis. Thus, further communications may be transmitted to one or more of the client personnel to obtain the required performance perception data.

Other technical advantages will be readily apparent to one skilled in the art from the following figures, descriptions and claims.

### BRIEF DESCRIPTION OF THE DRAWINGS

For a more complete understanding of the present invention and the advantages thereof, reference is now made to the following descriptions taken in connection with the accompanying drawings, in which:

FIG. 1 is a block diagram illustrating a performance measurement system in accordance with an embodiment of the present invention;

FIG. 2 is a block diagram illustrating performance metrics and performance queries of the system illustrated in FIG. 1 in accordance with an embodiment of the present invention; and

FIG. 3 is a flow chart of a method for performance measurement in accordance with an embodiment of the present invention.

### DETAILED DESCRIPTION OF THE INVENTION

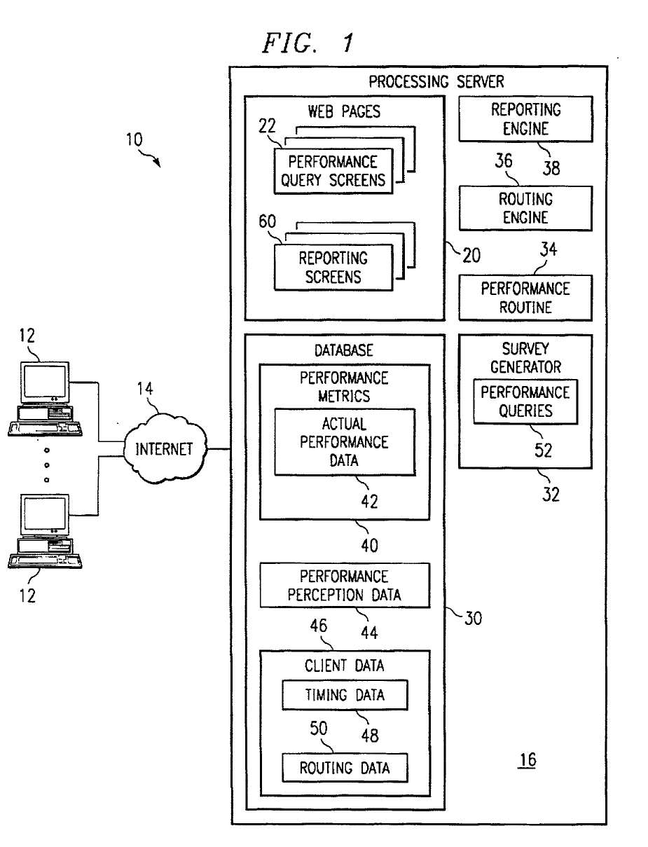

FIG. 1 is a block diagram illustrating a system 10 for performance measurement in accordance with an embodiment of the present invention. System 10 includes client user interfaces 12 for communicating via a communication network 14 to a processing server 16. A “client” may be any person or organization from which information is desired, such as a product purchaser, a service user or receiver, a partner of a business or enterprise, or any other transaction-related relationship. Correspondingly, a “provider” may be any person or entity desiring the performance information from the client, such as a provider of products or services. However, it should be understood that other types of relationships between a client and a provider may be used with system 10. User interfaces 12 may be any suitable graphical interface for use with communication network 14. Communication network 14 may be different networks, or the same network, and may include any Internet, intranet, extranet, or similar communication network.

Processing server 16 is preferably embodied as one or more computer programs running on a suitable processor or processors. Clients may use a web browser application running on user interface 12 to display data contained in files commonly identified as web pages 20. The client may display the data contained on web pages 20 and/or enter data onto entry fields contained on web pages 20. For example, web pages 20 may include one or more performance query screens 22 containing performance queries requiring a response from the client. The performance query screens 22 may also include data entry fields for receiving personal information from each of the responding client personnel, such as name, address, email address, telephone number, or other suitable personal information, and may also provide the responding client personnel the opportunity to update previously received personal information. As further illustrated in FIG. 1, processing server 16 also includes a database 30, a survey generator 32, a performance routine 34, a routing engine 36, and a reporting engine 38.

In the embodiment illustrated in FIG. 1, database 30 includes performance metrics 40 containing metrics for measurement terms and calculations used by a provider to manage processes, products, and other resources of a particular provider. For example, each metric may include a metric name, an algorithm required to compute the metric, and a source for the algorithm variable for computing the metric. The performance metrics 40 also include actual performance data 42 associated with each of the performance metrics 40. For example, actual performance data 42 may include particular values for variables used within the performance metrics 40 for computing a particular metric resource. Actual performance data 42 is generally received from or generated by the provider; however, the actual performance data 42 may be otherwise obtained or generated. Additionally, the actual performance data 42 may be located at other suitable storage locations and inputted into the performance metrics 40 as required.

Database 30 may also include performance perception data 44. Performance perception data 44 includes information received from a client via user interface 12 and communication network 14. For example, the client may provide performance information in response to one or more performance query screens 22 via user interface 12. The performance perception data 44 is stored in database 30 and compared to performance metrics 40 containing actual performance data 42. The performance perception data 44 generally includes information corresponding to a client's perception of provider performance. For example, the performance perception data 44 may include information related to how well the provider meets deadlines for delivering products or services to the client, the availability of the provider for communication with the client, provider response time to client requested changes or modifications to a particular product or service, and other types or performance related information.

In the embodiment illustrated in FIG. 1, database 30 also includes client data 46. Client data 46 may include information associated with particular clients interacting with a provider, such as receiving products or services from the provider, or may include other types of information generally corresponding to a particular client. In the illustrated embodiment, client data includes timing data 48 and routing data 50. Timing data 48 may include information associated with particular time periods for requesting performance perception data 44 from a particular client. For example, timing data 48 may include information associated with specific milestones or time periods during a project, information associated with the completion of a project, or information associated with predetermined time periods for receiving the performance perception data 44. However, timing data 48 may also include other types of timing information associated with receiving the performance perception data 44.

Routing data 50 may include information associated with a particular client for routing communications to the client corresponding to the performance perception data 44. For example, routing data 54 may include the names of client personnel required to provide the performance perception data 44, the mailing addresses of the corresponding client personnel, the email addresses of the corresponding client personnel, and other information associated with the client personnel that will receive a communication indicating that the survey requires attention. However, client data 46 may also include other suitable information associated with a particular client for determining time periods to generate surveys and corresponding routing information associated with the individuals required to respond to the survey.

Survey generator 32 generates a survey corresponding to a particular client for receiving the performance perception data 44. For example, survey generator 32 may include performance queries 52 corresponding to one or more performance metrics 40. Survey generator 32 may generate the performance query screens 22 or otherwise input the performance queries 52 into the performance query screens 22 for access by a client. The survey generator 32 may also be used to identify the web address corresponding to the performance query screens 22 and generate a communication to be transmitted to the client indicating the corresponding web address for the performance query screens 22. Alternatively, the performance query screens 22 may be preconfigured such that survey generator 32 transmits periodic communications to the client notifying the client that performance perception data 44 is requested.

Routing engine 36 may be used to transmit a communication to the client notifying the line of the survey and requesting performance perception data 44 corresponding to the survey. For example, routing engine 36 may retrieve routing data 50 from database 30 indicating client personnel or a particular client contact to receive a communication corresponding to survey notification. Routing engine 36 may then transmit the communication to the corresponding client contact or client personnel, thereby providing notification of the survey and providing the web address of the performance query screens 22 corresponding to the survey.

Performance routine 34 compares the performance perception data 44 received from the client with the performance metrics 40 and corresponding actual performance data 42 to determine variations between actual performance of the provider and a rating of the performance of the provider as perceived by the client. For example, one performance metric 40 may be associated with timeliness of providing products or services to the client. The actual performance data 42 associated with the timeliness metric 40 may include actual delivery and receipt information associated with the provided products or services. One of the performance query screens 22 may include a performance query 52 corresponding to the timeliness performance metric 40 and requesting from the client an indication as to the provider's ability and history of meeting product or service delivery deadlines. In response to receiving performance perception data 44 corresponding to the timeliness performance metric 40, performance routine 34 compares the performance perception data 44 with the corresponding timeliness performance metric 40 to determine variations between actual provider performance and a client's perception of the provider performance.

Reporting engine 38 generates a report containing the results of the comparison performed by the performance routine 34 and outputs the report to a printer or other suitable output device (not explicitly shown). For example, reporting engine 38 may generate one or more reporting screens 60 viewable as web pages 20 indicating a comparison of the performance metrics 40 with the performance perception data 44. As described above, one or more client personnel may be requested to access the performance query screens 22 and provide performance perception data 44 for one or more performance queries 52. Reporting engine 38 may also provide a report of the comparison between the performance perception data 44 and the performance metrics 40 using a variety of reporting schemes, breakdowns and/or techniques. For example, reporting engine 38 may generate a report of the comparison based on a particular performance metric 40, the client personnel providing the performance perception data 44, the level or rating provided by the client personnel, or any other suitable performance criteria. For example, the various reporting criteria generated by reporting engine 38 may be displayed on one ore more reporting screens 60.

In operation, survey generator 32 retrieves timing data 48 and generates a survey for a particular client corresponding to predetermined time periods or intervals. Alternatively, survey generator 32 may be configured to generate a survey automatically at predetermined time periods corresponding to the timing data 48. Survey generator 32 may also input the performance queries 52 into the performance query screens 22 for receiving the performance perception data 44 from the client. Survey generator 32 also retrieves routing data 50 for determining a client contact or client personnel to receive notification of the survey.

Routing engine 36 transmits a communication to the client notifying the client of the survey and identifying a web address for accessing the performance query screens 22. As described above, the communication notifying the client of the survey may be transmitted to identified client personnel or may be transmitted to a predetermined client contact, who may then transmit the communication to designated client personnel for providing the performance perception data 44. The client personnel access the performance query screens 22 via interfaces 12 and communication network 14 and respond to the performance queries 52 with the performance perception data 44.

After receiving the performance perception data 44 from one or more of the client personnel, performance routine 34 compares the performance perception data 44 with the corresponding performance metric 40 to determine variations between a perception of provider performance held by the client and actual provider performance. Reporting engine 38 generates a report of the variations between actual and perceived performance. As described above, reporting engine 38 may generate one or more reporting screens 60 for providing various methods of reviewing the comparison information. Additionally, as additional performance perception data 44 is received from the client, performance routine 34 and reporting engine 38 automatically update the results of the comparison on a substantially real-time basis. As described above, reporting engine 38 may provide the comparison information based on the client personnel providing the performance perception data 44. Thus, designated client personnel not responding to the survey may be identified from client data 46 and further communications sent to the corresponding client personnel at predetermined time intervals to prompt the client personnel to respond to the survey.

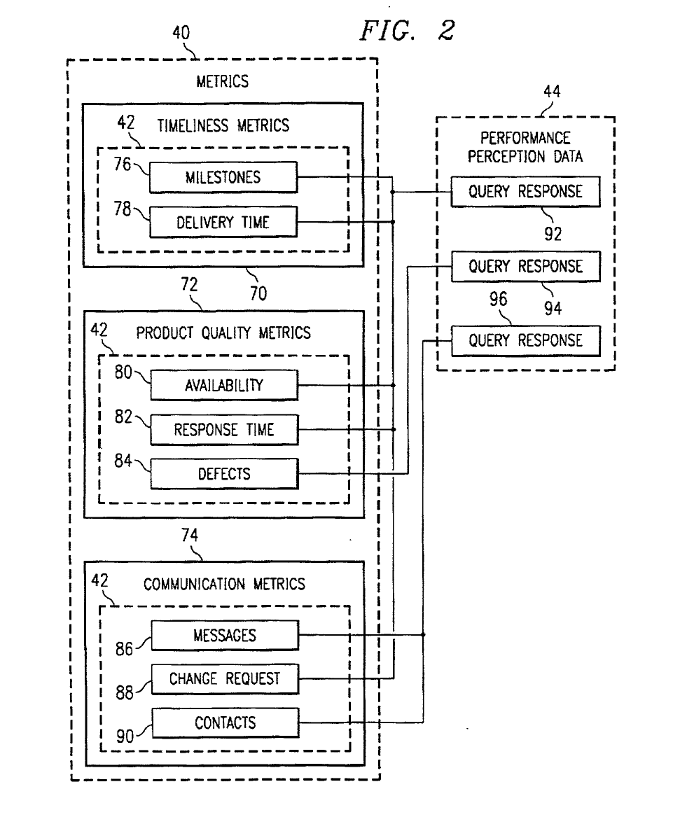

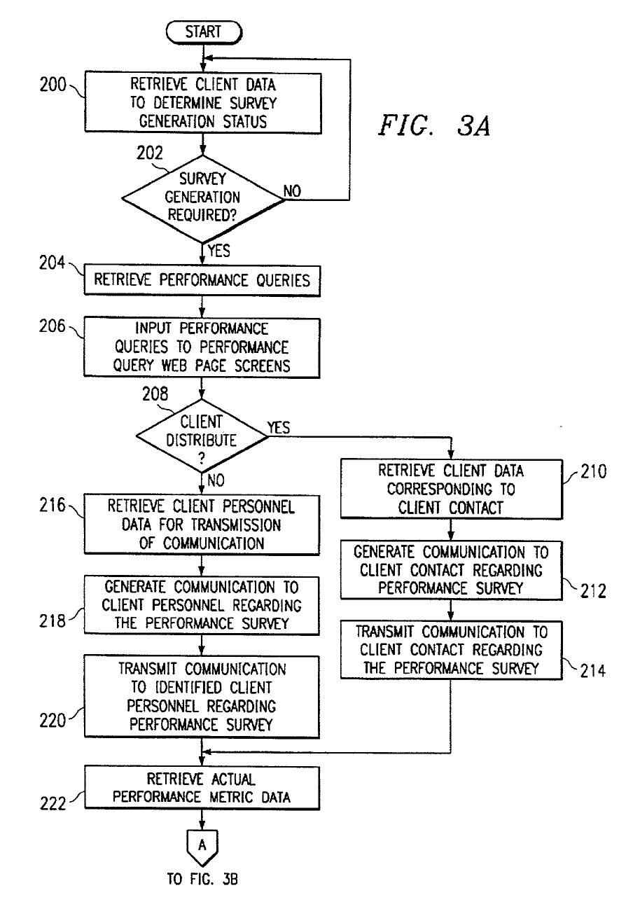

FIG. 2 is a block diagram illustrating performance metrics 40 and performance perception data 44 in accordance with an embodiment of the present invention. In the illustrated embodiment, performance metrics 40 include timeliness metrics 70, product quality metrics 72, and communication metrics 74. However, it should be understood that other suitable performance metrics 40 may be identified and used for evaluating actual and perceived performance.

In the embodiment illustrated in FIG. 2, timeliness metrics 70 include actual performance data 42 associated with milestones 76 and delivery time 78. For example, the actual performance data 42 corresponding to the timeliness metrics 70 may include information and/or values associated with product or service schedules and/or delivery dates. Product quality metrics 72 include actual performance data 42 corresponding to availability 80, response time 82, and defects 84. For example, the actual performance data 42 corresponding to the product quality metrics 72 may include information associated with service and/or product quality, such as product availability, product defects, time from request to delivery, and other suitable quality-based information. Communication metrics 74 include actual performance data 42 associated with messages 86, change requests 88, and contacts 90. For example, the actual performance data 42 corresponding to the communications metrics 74 may include information associated with customer service availability, responses to requested product or service changes, response time to respond to a product or service inquiry, and other suitable communication-based information. However, it should be understood that other types and forms of actual performance data 42 may be included in each of the performance metrics 40.

As illustrated in the embodiment illustrated in FIG. 2, performance perception data 44 may include query responses 92, 94, and 96. Query responses 92, 94, and 96 are received from a client in response to performance queries 52 displayed on performance query screens 22. Each query response 92, 94, or 96 may be used for comparison with one or more performance metrics 40 such that the quantity of performance queries 52 is substantially reduced, thereby providing a more efficient survey. For example, as illustrated in FIG. 2, query response 92 may be used for comparison with actual performance data 42 corresponding to milestone 96, delivery time 78, availability 80, response time 82, and change requests 88. Query response 94 may be used for comparison with actual performance data 42 corresponding to defects 84. Additionally, query response 96 may be used for comparison with actual performance data 42 corresponding to messages 86 and contacts 90. Thus, each query response provided by a client may be used for comparison with one or more performance metrics 40, thereby substantially reducing the quantity of performance queries 52 requiring a response by the client. The query responses 92, 94, and 96 may be in the form of a rating, numerical or verbal, or other type of response depending on the type and form of the performance query. For example, the query responses 92, 94, and 96 may require a rating from the client based on a numerical range from one to five, where five equates to superior and one equates to poor. However, other suitable responses may be used for the performance queries 52.

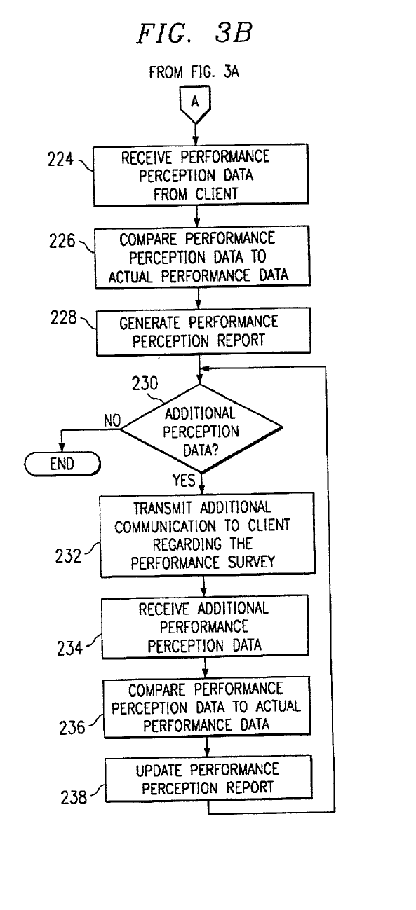

FIG. 3 is a flowchart illustrating a method for performance measurement in accordance with an embodiment of the present invention. The method begins at step 200, where survey generator 32 retrieves client data 46 to determine whether survey generation is required. For example, as described above, survey generator 32 may access timing data 48 to determine whether a predetermined time has been reached requiring generation of a survey, or may automatically generate the survey at a predetermined time period corresponding to the timing data 48. At decisional step 202, a decision is made whether generation of a survey is required. If the timing data 48 indicates that a survey is not yet required, the method returns to step 200, where survey generator 32 may retrieve the client data 46 on a periodic basis to determine whether survey generation is required. Alternatively, survey generator 32 may be configured to automatically generate the survey at a predetermined time period corresponding to the timing data 48.

If survey generation is required, the method proceeds from step 202 to step 204, where survey generator 32 retrieves the performance queries 52. At step 206, survey generator 32 inputs the performance queries 52 into the performance query screens 22 for access by the client personnel. At decisional step 208, a determination is made whether a communication to the client notifying the client of the survey will be transmitted to a client contact or directly to designated client personnel required to respond to the survey. If a client contact will distribute the communication to the designated client personnel, the method proceeds to step 210, where survey generator 32 retrieves the routing data 50 corresponding to the client contact. At step, 212, survey generator 32 generates a communication for transmittal to the client contact notifying the client contact of the survey and the corresponding web address of the performance query screens 22. At step 214, the routing engine 36 transmits the communication to the client contact.

If the communication is to be sent directly to designated client personnel, the method proceeds from step 208 to step 216, where survey generator 32 retrieves client data 46 corresponding to the designated client personnel. At step 218, survey generator 32 generates a communication for transmittal to the client personnel notifying the client personnel of the survey and the corresponding web address of the performance query screens 22. At step 220, the routing engine 36 transmits the communication to the designated client personnel notifying the client personnel of the performance survey and the web address for accessing the performance query screens 22.

At step 222, actual performance data 42 is received corresponding to each of the performance metrics 40. The actual performance data 42 may be input by provider personnel or may be automatically retrieved and updated from other data sources. At step 224, performance perception data is received from the client personnel corresponding to the performance queries 52 displayed on one or more of the performance query screens 22. At step 226, the performance routine 34 compares the received performance perception data 44 with the performance metrics 40 to determine variations between actual provider performance and the client's perception of provider performance. At step 228, reporting engine 38 generates a report of the variations between actual and perceived provider performance. For example, reporting engine 38 may generate one or more reporting screens 60 providing various breakdown methodologies for the comparison information.

At decisional step 230, a determination is made whether additional performance perception data 44 from the client personnel is received. For example, client data 46 may indicate predetermined client personnel required to respond to the performance queries 52. Performance routine 34 may evaluate the performance perception data 44 received and identify the client personnel yet to respond to the performance queries 52. If one or more of the designated client personnel have not provided performance perception data 44, the method proceeds to step 232, where survey generator 32 may transmit additional communications on a periodic basis to the designated client personnel or client contact requesting the performance perception data 44. At step 234, the additional performance perception data 44 is received from the remaining client personnel. At step 236, performance routine 34 compares the additional performance perception data 44 with the corresponding performance metrics 40. At step 236, reporting engine 38 updates the reporting screens 60 on a substantially real-time basis to reflect the additional performance perception data 44. The method then returns to step 230. If no additional performance perception data 44 is due from client personnel, the method terminates.

Thus, the present invention provides an efficient performance measurement system and method that also provides greater control over the survey process. Additionally, the client's perception of performance may be compared to actual performance so that variations between perceived and actual performance may be addressed and rectified.

Although the present invention and its advantages have been described in detail, it should be understood that various changes, substitutions, and alterations can be made therein without departing from the spirit and scope of the present invention as defined by the appended claims.

What is claimed is:

1. A Internet based performance measurement system, comprising:
a server operable to receive performance perception data from a client corresponding to a performance query;
a database comprising a metric corresponding to the performance query, the metric comprising actual performance data corresponding to the performance query; and
a performance engine operable to access the performance perception data and the metric, the performance engine operable to compare the performance perception data to the metric to determine variations between a client perception of performance and actual performance.

2. The system of claim 1, further comprising a reporting engine operable to generate a report of the variations.

3. The system of claim 1, wherein the performance data corresponds to a plurality of metrics.

4. The system of claim 1, further comprising a survey generator operable to generate and transmit a communication to the client corresponding to the performance query.

5. The system of claim 4, wherein the survey generator is operable to access client data to determine a time to generate the communication.

6. The system of claim 4, wherein the survey generator is operable to transmit the communication to a plurality of client personnel.

7. The system of claim 6, further comprising a reporting engine operable to generate a report of the variations for each of the client personnel.

8. A method for Internet based performance measurement, comprising:
generating a performance query web page having a performance query;
receiving performance perception data from a client corresponding to the performance query;
retrieving a metric corresponding to the performance query, the metric comprising actual performance data; and
comparing the performance perception data to the metric to determine variations between a client perception of performance and actual performance.

9. The method of claim 8, further comprising generating a performance report of the variations.

10. The method of claim 8, further comprising:
generating a communication corresponding to the performance query web page; and
transmitting the communication to the client.

11. The method of claim 10, wherein transmitting comprises transmitting the communication to a plurality of client personnel.

12. The method of claim 11, further comprising generating a performance report of the variations for each of the plurality of client personnel.

13. The method of claim 8, further comprising:
determining a time to generate a communication corresponding to the performance query from client data; and
transmitting the communication to the client at the determined time.

14. The method of claim 8, wherein receiving the performance perception data further comprises:
identifying one or more of the metrics corresponding to the performance perception data; and
routing the performance perception data to the corresponding identified metrics.

15. A method for performance measurement of a service provider, comprising:
generating a performance metric;
receiving actual performance data corresponding to the performance metric from the service provider;
generating a performance query corresponding to the performance metric;
receiving performance perception data associated with the performance query from a client; and
comparing the performance perception data to the performance metric to determine a difference between client performance perception and actual service provider performance.

16. The method of claim 15, further comprising transmitting a communication to the client notifying the client of the performance query.

17. The method of claim 16, wherein the client transmits the communication to one or more client personnel, the client personnel providing the performance perception data.

18. The method of claim 15, further comprising:
providing access to the performance query via a performance query web page;
generating a communication associated with an Internet address of the web page; and
transmitting the communication to the client.

19. The method of claim 15, further comprising generating a performance report of the variations.

20. The method of claim 15, wherein receiving the performance perception data comprises receiving the performance perception data from a plurality of client personnel, and further comprising generating and displaying a performance report corresponding to the performance perception data received from each of the plurality of client personnel.
